(19) United States
(12) Patent Application Publication
(10) Pub. No.: US 2022/0322703 A1
(43) Pub. Date: Oct. 13, 2022

(54) SOFT STUFFED PET TREAT

(71) Applicant: Spectrum Brands, Inc., Middleton, WI (US)

(72) Inventors: Gregory VAN EYK, Christiansburg, VA (US); Tiffany POTTER, Jr., Pearisburg, VA (US); Kelli STRAZAR, St. Charles, MO (US); Todd PALMER, O Fallon, MO (US)

(73) Assignee: Spectrum Brands, Inc., Middleton, WI (US)

(21) Appl. No.: 17/634,824

(22) PCT Filed: Aug. 14, 2020
(86) PCT No.: PCT/US2020/046420

§ 371 Date: Feb. 11, 2022

Related U.S. Application Data
(60) Provisional application No. 62/886,921, filed on Aug. 14, 2019.

(51) Int. Cl. A23K 10/30; A23K 50/20; A23K 50/75; A23K 50/80; A23K 50/10; A23K 20/174

(52) U.S. Cl. CPC A23K 10/30; A23K 50/20; A23K 50/75; A23K 50/80; A23K 50/10; A23K 20/174

(57) ABSTRACT

The present disclosure provides compositions and methods for a pet treat. The present pet treat has an inner portion and an outer portion, and optionally a hollowed space confined by the inner portion. The inner portion may comprise a grain-based composition and a plurality of cavities enclosed therein. The outer portion may comprise a meat-based composition. The inner portion and the outer portion of the pet treat have different compositions and characteristics, which enables the pet treat to have a crunchy and/or crispy palatability profile when chewing.

### CROSS-REFERENCE TO RELATED APPLICATION

This application is being filed on 14 Aug. 2020, as a PCT International patent application, and claims priority to U.S. Provisional Patent Application No. 62/886,921, filed Aug. 14, 2019, the entirety of which is incorporated herein by reference.

### INTRODUCTION

Pet owners have a multitude of pet treats to choose from, including rawhide, jerky treats, dental treats, soft treats, and biscuits. Pet treats are usually made of either animal parts or starch-based material. Regardless of the ingredients, dogs and cats tend to prefer treats that contain meat or are flavored to taste like meat. Protein based products are desired because dogs have an attraction to protein.

Traditional pet treat or pet chew products consist essentially of rawhide or dehydrated rawhide, which has high density and toughness. Although rawhide can sustain chewing in a dog's mouth for relatively long time, it actually does not maintain a dog's interest due to the limited acceptability. Manufacturers have attempted to solve this problem of reduced acceptability by incorporating numerous ingredients and processing techniques into the manufacture of rawhide-based chews for dogs, such as incorporating meat in the middle of a rawhide stick.

Despite this, the basic problem remains. Most of these treats in the art are heavily meat-based treats, which are often high in calories, fat, and sodium. Some of these types of treats include pet jerky, meat filled treats, meat filled rawhide, and the like. Consumption of treats, such as these, in addition to a normal pet diet, easily leads to caloric consumption beyond recommended daily allowances. Additionally, these treats are dense in weight and calories, thus consumption of only a few treats can lead to a great increase in caloric intake. Further, many of the traditional meat-based treats are not visually appealing to pets. Most of them contain densely packed meat portions that lack unique visual and acoustic effects when chewed by pets. These pet treats also do not give the pet owner an acceptable reaction when purchasing the pet treat.

Therefore, what is needed is a pet treat that provides a texturally or visually appealing product that stimulates a human to purchase the pet treat. What is also needed is a pet treat that produces a unique acoustic palatability or a sound profile when initially chewed by a pet and attracts the pet to remain interested in the treat. In addition, it is also desirable for multi-component pet treat having balanced meat and other nutrients.

### Soft Stuffed Pet Treat

### Summary of Disclosure

The present disclosure overcomes the problems inherent in the prior art and provides for a distinct advance in the art. In some aspects, the present disclosure relates to a pet treat comprising an inner portion and an outer portion circumferentially wrapped around the inner portion, wherein the inner portion has a first density and comprises a grain-based composition, and the outer portion has a second density and comprising a meat-based composition, and the first density is less than the second density.

In some embodiments, the pet treat further comprises a hollowed space confined by the inner portion and around a central axis of the pet treat. In some embodiments, the hollowed space is through an entire length of the pet treat.

In some embodiments, the pet treat further comprises a plurality of cavities on or within the inner portion, wherein a substantial portion of the cavities are fully encapsulated by the inner portion.

In some embodiments, the pet treat is substantially straight through a length thereof. In some embodiments, the pet treat has a substantially cylindrical configuration and a substantially uniform cross-section through a length thereof. In some embodiments, the inner portion has a substantially circular cross-section. In some embodiments, the outer portion has a substantially uniform ring-like cross-section.

In some embodiments, the inner portion is not substantially covered by the outer portion and thereby invisible at a first side, or a second side, or both, of the pet treat. In other embodiments, the inner portion is substantially covered by the outer portion and thereby invisible at a first side, or a second side, or both, of the pet treat.

In some embodiments, the pet treat has an aspect ratio from about 1 to about 20, or from about 2 to about 15, or from about 3 to about 10, or from about 4 to about 5. In some embodiments, the pet treat has a length from about 1 cm to about 50 cm, or from about 2 cm to about 40 cm, or from about 3 cm to about 30 cm, or from about 4 cm to about 20 cm, or from about 5 cm to about 15 cm, or from about 6 cm to about 12 cm.

In some embodiments, the pet treat has a weigh from about 1 g to about 50 g, or from about 5 to about 30 g, or from about 10 g to about 20 g.

In some embodiments, the grain-based composition of the present pet treat comprises at least one grain selected from the group consisting of wheat, oat, rice, corn, maize, barley, sorghum, rye, millet, amaranth, buckwheat, quinoa, or combinations thereof.

In some embodiments, the grain-based composition comprises a flour selected from the group consisting of oat flour, soy flour, wheat flour, rice flour, potato flour, corn flour, rye flour, buckwheat flour, chestnut flour, chickpea flour, atta flour, pea flour, bean flour, amaranth flour, arrow root flour, taro flour, cattail flour, acorn flour, sorghum flour, or tapioca flour, or a combination of two or more thereof.

In some embodiments, the meat-based composition of the outer portion comprises a meat from at one least one animal selected from a group consisting of pork, beef, chicken, duck, goat, horse, buffalo, venison, elk, moose, liver, fish, veal, lamb, turkey, goose, shellfish, bovine, porcine, and combinations thereof.

In some embodiments, the pet treat comprises an anti-oxidant rich material selected from the group consisting of acai berries, blueberries, blackberries, spinach, brown rice, quinoa, chia seeds, flax seeds, wheat grass, pumpkin, salmon, kiwi, asparagus, and combinations thereof.

In some embodiments, pet treat comprises a starch composition derived from one or more plants selected from the group consisting of potatoes, rice, tapioca, corn, rye, wheat, and oats, fruits, nuts, rhizomes, arrowroot, guar gum, locust bean, arracacha, buckwheat, banana, barley, cassava, konjac, kudzu, oca, sago, sorghum, sweet potato, taro, yams, fava beans, lentils and peas.

In some embodiments, the present pet treat comprises one or more useful components such as auxiliary ingredients, health ingredients, supplemental ingredients, and food additives. These useful components or ingredients may be present within the inner portion, or the outer portion, or both, or at the interface of the inner portion and the outer portion, or on an outer surface of the pet treat, or in any part thereof.

The auxiliary ingredient may comprise a plant material selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, swiss chard, turnip greens, Jerusalem artichoke, jicama, lettuce, mushrooms, okra, onion, parsley, peas, peppers, plantain, pumpkin, radicchio, radish, rutabaga, spinach, sweet potato, tomato, turnip, water chestnut, yams, and combinations thereof.

The useful component may comprise an ingredient selected from the group consisting of food additive, preservative, sorbitol, desired colorant, glycerin, yeast extract, flavor, salt, cochineal, potassium sorbate, and combinations thereof.

The food additive may comprise an ingredient selected from the group consisting of binding agent, a moisturizing compound, a salt, a sugar, a caramel, an acid, a mold inhibitor, a flavoring compound, an aroma compound, a coloring compound, and any combination of two or more thereof.

The health ingredient may comprise an ingredient selected from the group consisting of glucosamine, chondroitin, flax seed, calcium, parsley seed, peppermint, chlorophyll, vitamin E, L-carnitine, and lycopene, and combinations thereof.

The coloring compound may comprise an ingredient selected from a group consisting of caramel coloring, malliouse, allura red AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, saffron, sunset yellow FCF, tartrazine, titanium dioxide, turmeric, yellow 5, yellow 2, or any combination of two or more thereof.

In some aspects, the present disclosure relates to a method of making a pet treat described herein. In some embodiment, a method of making a pet treat comprises providing a grain-based composition and a meat-based composition; configuring the grain-based composition, whereby forming an inner portion; and wrapping the inner portion with the meat-based composition thereby forming the pet treat, wherein the outer portion circumferentially covers at least a substantial portion of the inner portion. The present method may further comprise forming an internal hollowed space of the inner portion around a central axis of the pet treat. The present method may further comprise forming a plurality of cavities on or within the inner portion. A substantial portion of the cavities may be fully encapsulated by the grain-based composition. Forming a plurality of cavities may comprises injecting a gas into the grain-based composition during extrusion. Wrapping the inner portion with the meat-based composition may be performed manually or automatically by a machine.

In other embodiments, a method of making a pet treat comprises providing a grain-based composition and a meat-based composition; coextruding the grain-based composition and the meat-based composition, whereby forming the pet treat, wherein the grain-based composition forms the inner portion, and the meat-based composition forms the outer portion, and wherein the outer portion circumferentially covers at least a substantial portion of the inner portion. The present method may further comprise forming an internal hollowed space of the inner portion around a central axis of the pet treat during the coextrusion. The present method may further comprise forming a plurality of cavities on or within the inner portion. A substantial portion of the cavities may be fully encapsulated by the grain-based composition. Forming a plurality of cavities may comprises injecting a gas into the grain-based composition during the coextrusion.

### Selected Definitions

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %, etc.

As used herein, “g” represents gram; “oz” represents ounce, and one ounce is equivalent to about 28.35 g; “L” represents liter; “mg” represents “milligram (10⁻³ gram);” “mL” represents milliliter (10⁻³ liter); “cm” represents centimeter (10⁻² meter); “mm” represents millimeter (10⁻³ meter); one inch is equivalent to about 2.54 cm. The unit of temperature used herein is degree Celsius (° C.).

“Aspect ratio” used herein refers to the ratio of the length or height of a three-dimensional object to the cross-section width thereof.

The term “about” is used in conjunction with numeric values to include normal variations in measurements as expected by persons skilled in the art, and is understood have the same meaning as “approximately” and to cover a typical margin of error, such as ±10% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### BRIEF DESCRIPTION OF THE DRAWINGS

FIG. 1 illustrates an embodiment of the pet treat according to the present disclosure.

FIG. 2 illustrates another embodiment of the pet treat according to the present disclosure.

FIG. 3 illustrates a side view of an embodiment according to the present disclosure.

FIG. 4 illustrates another embodiment of the pet treat according to the present disclosure.

### DETAILED DESCRIPTION

The present disclosure provides compositions and methods for making pet food treats or pet chews. In some aspects, the present disclosure relates to a pet treat comprising an inner portion and an outer portion circumferentially wrapped around the inner portion, wherein the inner portion has a first density and comprises a grain-based composition, and the outer portion has a second density and comprising a meat-based composition, and the first density is less than the second density.

The present disclosure is based upon the discovery that pet treats having a multi-component configuration and a combination of meat-based composition and grain-based composition separately in the components will provide unique textural, visual, and taste palatability, and will stimulate an animal and increase an animal's interest in consuming the treat. Moreover, the one or more components of the pet treat could be puffed or aerated by encapsulating a hollowed space and/or a plurality of cavities or holes or channels therein. It is surprisingly found that the pet treat having a hollowed space and/or a plurality of cavities therein could produce unique crunchy and crispy effects that unexpectedly attract and prolong the pets' interests when chewing. Such crunchiness and crispiness provide a unique acoustic palatability profile. In addition, the pet treat may provide a balanced and healthier diet, allowing the pet to have intake of both meat and plant-based ingredient concurrently when eating the pet treat.

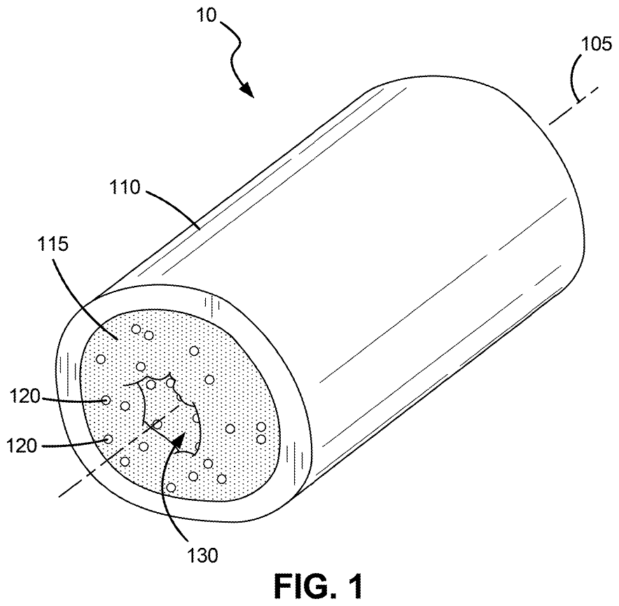

Now referring to FIGS. 1-4, particular embodiments of the pet treat will be described. FIG. 1 shows an embodiment of pet treat 10 having a longitudinal central axis 105. Pet treat 10 comprises an inner portion 115 and an outer portion 110. The inner portion 115 is circumferentially wrapped by the outer portion 110. The outer portion 110 surrounds and covers a substantial portion of an outer surface of the inner portion 115.

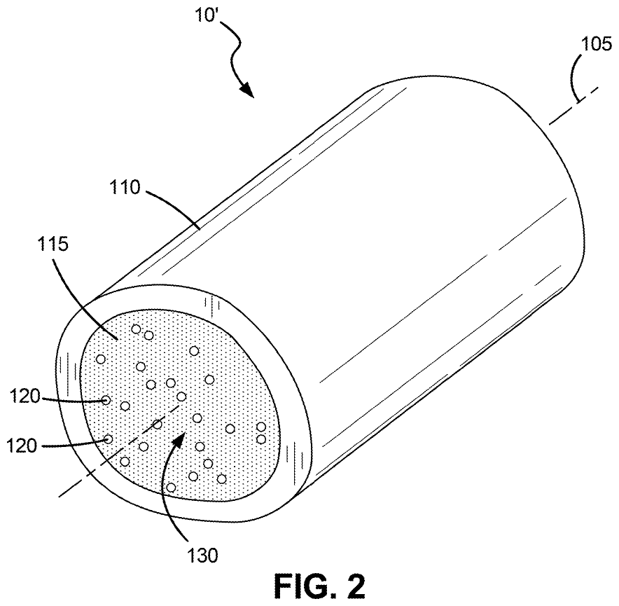

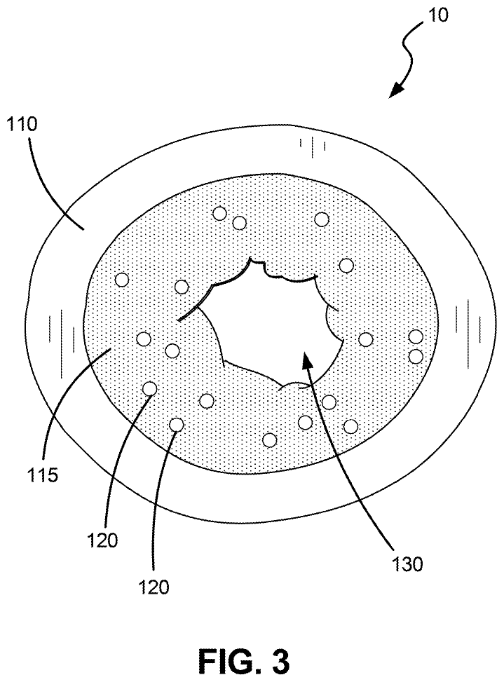

Pet treat 10 may further comprise a hollowed space 130 confined by the inner portion 115 and centered around the central axis of the pet treat. The hollowed space 130 may be through an entire length of the pet treat 10, as shown in FIG. 3. FIG. 2 shows another embodiment pet treat 10′, wherein the hollowed space 130 may be partially or fully encapsulated by the inner portion 115, being invisible from one side or both two sides or the pet treat 10′. In such cases, the hollowed space may be either continuous or separated within the inner portion 115. Alternatively, pet treat 10′ may not have a hollowed space within the inner portion (not shown).

The pet treat 10 may be substantially straight through a length thereof. The pet treat 10 may have a substantially cylindrical configuration and a substantially uniform cross-section through a length thereof. The cross-section of the pet treat 10 may have various geometries including but not limited to circular, ellipse, square, rectangular, triangle, or other regular and irregular shapes. Likewise, the inner portion 115 may have a substantially uniform cross-section of various geometries. Similarly, the hollowed space 130 may have a cross-section of any possible regular or irregular geometries as described herein. The hollowed space 130 may have various cross-section size and width, limited by the size of the inner portion 115.

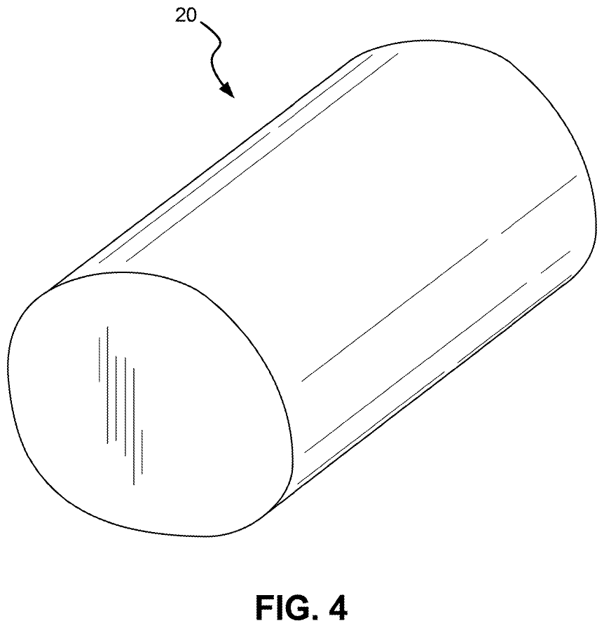

The pet treat 10 may extend from a first side to a second side along the central axis 105. As shown in FIG. 1, the inner portion 115 and/or the hollowed space 130 may not be substantially covered by the outer portion 110 at the first side, or the second side, or both, of the pet treat. Accordingly, the inner portion 115 and/or the hollowed space 130 are visible from the side, as shown in FIG. 3. In other embodiments, such as the pet treat 20 shown in FIG. 4, the inner portion 115 and/or the hollowed space 130 may be covered or substantially covered by the outer portion 110 at the first side, or the second side, or both, of the pet treat. Accordingly, the inner portion 115 and/or the hollowed space 130 are invisible from the first side, or the second side, or both. In other embodiments, the inner portion 115 and/or the hollowed space 130 may be partially covered at the first side, or the second side, or both, of the pet treat. In yet other embodiments, the inner portion 115 may be fully or substantially covered by the outer portion 110, but the hollowed space 130 may not be substantially covered by the outer portion 110, at the first side, or the second side, or both, of the pet treat 10.

Preferably, the pet treat 10 comprises a plurality of cavities 120, wherein a substantial portion of the cavities 120 are fully encapsulated by the inner portion 115. The cavities 120 may have various shapes and sizes ranging from about 1 micron to about 2 cm. The cavities 120 may be distributed within the inner portion 115, at the interface between the inner portion 115 and the outer portion 110, or at the interface between the inner portion 115 and the hollowed space 130, or at one or both sides of the pet treat 10. The cavities 120 may be uniformly distributed both longitudinally and radially through an entire length of the pet treat 10. The cavities 120 may be discretely separated, or they may be interconnected, forming longer/larger space or channels within or through the pet treat 10. The cavities 120 may be filled with a gas, depending on the process of generating the cavities. The gas may be air, N₂, or an inert gas like Ar that is introduced to the cavities during their formation. The cavities 120 and/or the hollowed space 130 will deform or compress or collapse when a pet chews the pet treat 10, thereby releasing the gas filled therein, producing a crispiness effect and/or crunchy sound profile, which auditorily stimulates and attracts and the pet consuming the pet treat.

The inner portion 115 has a first density, and the outer portion 110 has a second density, and the first density is less than the second density. The density may be in an range from about 0.1 g/cm³ to about 2 g/cm³, from about 0.2 g/cm³ to about 1.5 g/cm³, from about 0.3 g/cm³ to about 1.2 g/cm³, from about 0.4 g/cm³ to about 1 g/cm³, or from about 0.5 g/cm³ to about 0.8 g/cm³. The first density may be about 10%, or about 20%, or about 30%, or about 40%, or about 50%, or about 60%, or about 70%, or about 80%, or about 90%, or about 95% of the second density. Preferably, the inner portion 115 is softer than the outer portion 110.

The inner portion 115 comprises a grain-based or a plant-based composition, and the outer portion 110 comprises a meat-based composition. The inner portion and the outer portion may be different with respect to other characteristics such as formulation, ingredient, color, texture, softness, toughness, flavor, and so on. The multilayered or multi-component configuration with disparate characteristic between the inner portion and the outer portion produces a unique taste profile that is different from a traditional pet treat having a single-component configuration or a homogenous blend of ingredients.

The pet treat 10 may have an aspect ratio from about 1 to about 20, or from about 2 to about 15, or from about 3 to about 10, or from about 4 to about 5. The pet treat 10 may have a length from about 1 cm to about 50 cm, or from about 2 cm to about 40 cm, or from about 3 cm to about 30 cm, or from about 4 cm to about 20 cm, or from about 5 cm to about 15 cm, or from about 6 cm to about 12 cm. The pet treat 10 may have a weight from about 1 g to about 50 g, or from about 5 to about 30 g, or from about 10 g to about 20 g. The aspect ratio, length, weight, or other specifications of the pet treat may vary depending on consumer needs.

The inner portion 115 may be from about 5% to about 80%, or from about 10% to about 60%, or from about 15% to about 40%, or from about 20% to about 30%, based on the total weight of the pet treat.

The outer portion 110 may be from about 20% to about 95%, or from about 30% to about 80%, or from about 40% to about 70%, or from about 50% to about 60%, based on the total weight of the pet treat.

The composition and method of making a pet treat are described herein. A method of making a pet treat 10 generally includes providing a meat-based composition as a base material used for forming the outer portion 110.

The meat-based composition or meat base is made from animal meat and may comprise boneless chicken, duck, chicken liver and combinations thereof. The animal meat may be fresh, dehydrated, powdered, and extract or frozen. The frozen animal meat is defrosted at about 0° C. to about 5° C. Once the animal meat is defrosted, the animal meat is weighed. Once the predetermined amount of animal meat is weighed, the meat is placed in a grinder, the animal meat(s) is ground and mixed with the specific desired ratio of animal meat(s) and stored in a container as a meat base. It should be noted that the meat base may be frozen for later use, or may be used immediately after the meat base is prepared. Further, one should appreciated that although boneless chicken, duck and chicken liver are noted, the meat base can also include beef, pork, lamb, goat, horse, buffalo, venison, elk, moose, chicken, turkey, fish, or any other seafood, or any combination of two or more thereof. Alternatively, the meat base need not include boneless chicken, duck and/or chicken liver and may comprise beef, pork, lamb, goat, horse, buffalo, venison, elk, moose, bone-in chicken, turkey, fish, or any other seafood, or any combination of two or more thereof. The term “meat” associated with “meat base” and “meat mixture” are intended to encompass parts of animals, mammal and non-mammal, that can be used for a pet treat. This includes but is not limited to soft tissue, internal organs, cartilage and bone.

In one embodiment of the disclosure, chicken meat is used as a meat base. Chicken meat can include, for example, necks, breasts, or backs, or any combination of two or more thereof, with or without cartilage and/or bone ground to small sizes (i.e., emulsified). Chicken meat can also include necks, breasts, or backs, or any combination of two or more thereof that are boneless and ground to desired sizes. Chicken meat can include mechanically separated chicken (MSC). Chicken meat can also include a mixture of boneless or bone-in chicken, mixed together in various portions. The chicken meat is used in an amount of about 5-100% by weight of the meat-based composition. It should be appreciated that the other animal sources, including various sections of the animal can be used to provide a final taste or consistency for the meat. In embodiments where other meat sources are used, the total meat content is 5% to 100% by weight of the meat-based composition.

The method of making a pet treat 10 generally includes providing a grain-based composition as a base material for forming the inner portion 115. The grain-based composition comprises a grain or a flour or a starch derived from a plant. The plant may include wheat, oat, rice, corn, maize, barley, sorghum, rye, millet, amaranth, buckwheat, quinoa, or combinations thereof.

The flour includes but is not limited to oat flour, soy flour, wheat flour, rice flour, potato flour, corn flour, rye flour, buckwheat flour, chestnut flour, chickpea flour, atta flour, pea flour, bean flour, amaranth flour, arrow root flour, taro flour, cattail flour, acorn flour, sorghum flour, or tapioca flour, or a combination of two or more thereof. The flour may be incorporated in amount of no more than 25% by weight of the grain-based composition. The flour may be present between about 1-50% including but not limited to 1%, 10%, 15%, 20%, 25%, 30%, 35%, 40%, 45%, 50%, based on the total weight of the pet treat. Alternatively, the starch may be at least 1%, 5%, 10%, 15%, 20%, 25%, 30%, 35%, 40%, 45%, 50%, based on the total weight of the pet treat.

The pet treat 10 may include other useful or beneficial components, such as auxiliary ingredient, food additive, health ingredient, supplemental ingredient, etc. These components or ingredients may be present in the inner portion 115, in the outer portion 110, or in both, or at the interface between the inner portion 115 and the outer portion 110, or in any part of the pet treat 10.

A useful component is a starch or any carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassava, konjac, kudzu, oca, sago, sorghum, sweet potato, taro, yams, fava beans, lentils and peas. The starch may be present between about 1-50% including but not limited to 1%, 10%, 15%, 20%, 25%, 30%, 35%, 40%, 45%, 50%, based on the total weight of the pet treat. Alternatively, the starch may be at least 1%, 5%, 10%, 15%, 20%, 25%, 30%, 35%, 40%, 45%, 50%, based on the total weight of the pet treat.

The starch employed herein may be raw starch, which may be understood as starch that has not seen a prior thermal molding history, such as extrusion or other type of melt processing step. The raw starch itself may also be native, which may be understood as unmodified Starch recovered in the original form by extraction and not physically or chemically modified. The raw starch may also be in powder form of varying particle size, which may be understood as milled and/or pre-sifted. It should be understood that the raw starch may also have varying degrees moisture present. The starch composition may include cellulose. The cellulose may be, for example, a long-chain polymer of polysaccharide carbohydrate. The cellulose may also be derived or extracted from plants. The cellulose may be incorporated into the starch composition between about 1-10% by weight of the starch composition.

Another useful component is a plant material, such as a fruit, vegetable, vegetable protein, fruit extract, vegetable extract and combinations thereof that can be consumed by a domestic pet. The plant material may be present in the inner portion 115, in the outer portion 110, or in both, or at the interface between the inner portion and the outer portion, or in any part of the pet treat 10. The plant material may be fresh, dehydrated, powdered, an extract or frozen. In embodiments where the plant material is frozen the plant material is defrosted at about 0° C. to about 5° C. Once the plant material is defrosted, the plant material is weighed. Once the predetermined amount of plant material is weighed, the plant material is placed in a grinder, the plant material(s) is ground and mixed with the specific desired ratio of plant material (s) and stored in a container as a plant base. It should be noted that the plant base may be frozen for later use, or may be used immediately after the plant base is prepared. The plant base may be mixed with the meat-based composition or mixed with the grain-based composition.

A plant base material, as used herein, means a fruit, vegetable, vegetable protein, fruit extract and vegetable extract that can be consumed by a domestic pet, such as a dog.

In one embodiment of the disclosure, the plant base may include fruits such as, apple, apricot, banana, black berry, blackcurrant, blueberry, coconut, cherry, cherimoya, date, durian, fig, feijoa, gooseberry, grape, grapefruit, jack fruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit and combinations thereof.

The plant base may include vegetables such as, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, Sweet potato, tomato, turnip, water chestnut, yams, and combinations thereof.

Additionally, the plant base may comprise herbs, herbal extracts, vitamins, minerals, yeast products, soy products, may be incorporated into the plant base. Further, the plant base may also include food sources that provide phytochemicals. A non-exclusive list phytochemicals include: carotenoids, lycopenes, beta cryptozanthin, flavonoids, indoles, Sulforaphane, isoflavones, allicin, genistein, polyphenols, anthocyanins, limonoids, sterols, capsaicin, elegiac acid and lignans.

In one example embodiment carotenoids are included in the plant base. In at least this example embodiment the carotenoids are included from a plant selected from a group consisting of carrots, cantaloupe, papaya, pumpkin, squash, sweet potatoes, broccoli, dried apricots, asparagus, kale, green leafy vegetables and combinations thereof. In related embodiments lycopenes are included in the plant base. The lycopenes are added with the addition of plants selected from a group consisting of tomatoes, tomato paste, tomato juice, guava, pink grapefruit, watermelon and combinations thereof. In other related embodiments, beta cryptozanthin are included in the plant base. Beta cryptozanthin are found in plants such as tangerines, papaya, oranges, peaches, mangoes, nectarines and combinations thereof.

In other example embodiments flavonoids extracted from plants such as soy, green tea, tomatoes, sweet potatoes, cruciferous vegetables such as broccoli, cabbage, brussels sprouts, mustard greens, kale, and cauliflower, citrus fruits, onions and combinations thereof can be used in the plant base. In other example embodiments, indoles and sulforaphane, which are commonly found in cruciferous vegetables are added to plant base. Examples of cruciferous vegetables include, but are not limited to cauliflower, cabbage, garden cress, bokchoy, broccoli and brussels sprouts. in other related embodiments, isoflavones are included in plant base. Isoflavones are commonly found in legumes, Such as beans, peas and lentils and soy products. In other related embodiments, allicin is added to the plant base, which can be found in plants such as onions and garlic. In example embodiments genistein is added through the addition of soy products, such as tofu. In other example embodiments, polyphenols can be added through the addition of green tea.

In yet other related embodiments, anthocyanins found in plants such as wild blueberries, bilberries and black berries can be included in plant base. Limonoids, found in citrus fruits such as clementine, grapefruit, kumquat, lemon, lime, mandarin, orange, tangerine and the like can also be added to plant base. In other embodiments, sterols from cruciferous vegetables, cucumbers, squash, sweet potatoes, soy foods, eggplant, whole grains, tomatoes and the like are included in plant base. In embodiments where the addition of capsaicin is desired, the phytochemical can be added by including chili peppers. Similarly, in embodiments where elegiac acid is desired strawberries can be included in plant base. The addition of lignans, can be achieved by the addition of nuts and seeds. It should be appreciated that the addition of certain plants will include more than one phytochemical listed herein. Further, extract(s) of the aforementioned plants can be added to specifically add a desired phytochemical or combination of phytochemicals to the plant base.

Other sources of important nutrients for animals may also include seaweed, kelp, bluegreen algae, spirulina, Irish moss, dulse, nori, kombu, wakeme, alfalfa, fenugreel seed, wheatgrass, barleygrass and marine phytoplankton.

The plant material may be used in an amount of about 5% to 100% of the pet treat 10. It should be appreciated that the other plant sources, including various extracts, can be used to provide a final taste or consistency for the pet treat 10. In embodiments where other plant sources are used, the total plant content is 1% to 70% by weight of the entire pet treat.

Auxiliary ingredients present in the pet treat may include a binding agent, a salt, a sugar, an acid, a mold inhibitor, a flavoring compound, an aroma compound, a coloring compound, a moisturizing compound or any combination of two or more thereof.

The binding agent can be used in an amount between about 10% and about 75% by weight of the meat-based composition. In one example embodiment the binding agent is about 20% by weight of the meat-based composition. The type and amount of binding agent can be selected so that the resulting product is not sticky and no residue is left on the pet owners finger-tips or households surfaces, such as carpets. For example, the binding agent can be added to “buffer or to absorb fat content in the meat-based composition. The binding agent can also facilitate the blending of the various ingredients and allow the meat-based composition to hold a shape prior to being dried.

The binding agent can include, but is not limited to, oat flour, soy flour, wheat flour, rice flour, potato flour, corn flour, rye flour, buckwheat flour, chestnut flour, chickpea flour, atta flour, pea flour, bean flour, amaranth flour, arrow root flour, taro flour, cattail flour, acorn flour, sorghum flour, or tapioca flour, or a combination of two or more thereof. The flour, in this case wheat flour, is incorporated in amount of no more than 25% by weight of the meat-based composition.

The aroma compound or flavoring compound, provide palatability enhancement respectively and include, but are not limited to, garlic (e.g., garlic concentrate, garlic oil, garlic powder, garlic aroma), onion (e.g., onion concentrate, onion oil, onion powder, onion aroma), natural smoke flavor, hickory, mesquite, anchovy, chicken, lobster, tikka, tandoori, parsley, spinach, saffron, digestive (liquid stomach contents of an animal, e.g., chicken), phosphate, yeast, or enzymatic liver (pork, turkey or chicken), or any derivative thereof, or any combination of two or more thereof. Additionally salt may be added to enhance flavor and can also provide particle binding in forming the meat-based composition.

Coloring compounds provide cosmetic enhancement respectively and include, but are not limited to, caramel coloring, malliouse, allurared AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, Saffron, Sunset yellow FCF, tartrazine, titanium dioxide, turmeric, yellow 5. yellow 2, or any combination of two or more thereof.

The humectant can be used to reduce water activity. Water activity is a measure of the availability of water in a food for microbial growth such as molds. Water activity is a primary method of controlling antimicrobial or mold growth. One example range of water activity is an aW value of less than 0.7. The humectant including sugar, or sugar alcohols can be used in an amount between about 0% and about 20% by weight of the meat-based composition, for example about 15% to 18% by weight of the meat-based composition. The humectant, can include, but is not limited to fructose, dextrose, maltodextrin, honey, high-fructose corn syrup, maltose, brown sugar, coconut sugar, date sugar, sucanat, molasses, turbinado sugar, dextrin, glucose, sucrose. sucralose, glycerin or any derivative thereof, or any combination of two or more thereof.

Another useful component is a mold inhibitor. A non-exclusive list of mold inhibitors include, but is not limited to, potassium sorbate, cultured whey, calcium propionate, cultured dextrose, cultured yeast, benzoic acid, acetic acid, or plum powder, or any derivative thereof or any combination of two or more thereof.

A moisturizing compound can be used in a range of between 2% and 20%. For example, a moisturizing compound, such as water, will aid in formation of the grain-based composition or meat-based composition. For example, the moisture content of the entire pet treat may be above 20% prior to drying the pet treat, but will achieve a moisture content below 20%, for example 18%, in the final pet treat product.

It should be appreciated that each of the components or ingredients described above is optional. Such as the ingredients with a percentage range starting at 0%. The grain-based composition and the meat-based composition may be prepared, stored, and delivered by mixing the desired ingredients using standard facility and process known in the art.

Tables 1-3 show formulations of non-limiting examples of the present pet treat. It is again noted that the pet treat may comprise combination of meat from various animals as described herein.

TABLE 1
Formulation of an embodiment pet treat comprising chicken meat.

| | | Species of Animal |
|---|---|---|
| Ingredient | % | Origin |
| Chicken | 45-65 | (i.e. Avian) |
| Rice Flour | 5-25 | / |
| Starch | 5-25 | / |
| Glycerin | 5-20 | / |
| Sorbitol | .1-10 | / |
| Yeast Extract | .2-1.5 | / |
| Salt | .2-1.5 | / |
| Potassium sorbate | .005-.01 | / |
| Cochineal | 0.004-.01 | / |
| Total Ingredients: | 100 | — |

TABLE 2
Formulation of an embodiment pet treat comprising duck meat.

| | | Species of Animal Origin |
|---|---|---|
| | | (Example: Shellfish, |
| Ingredient | % | Bovine, Porcine, etc.) |
| Duck | 45-65 | (i.e. Avian) |
| Rice Flour | 5-25 | / |
| Starch | 5-25 | / |
| Glycerin | 5-20 | / |
| Sorbitol | .1-10 | / |
| Yeast extract | .2-1.5 | / |
| Salt | .2-1.5 | / |
| Potassium sorbate | .005-.01 | / |
| Cochineal | .004-.009 | |
| Total Ingredients: | 100 | — |

TABLE 3
Formulation of an embodiment pet treat comprising beef meat.

| | | Species of Animal Origin |
|---|---|---|
| | | (Example: Shellfish, |
| Ingredient | % | Bovine, Porcine, etc.) |
| Beef | 45-65 | (i.e. Bovine) |
| Rice Flour | 5-25 | / |
| Starch | 5-25 | / |
| Glycerin | 5-20 | / |
| Sorbitol | 2.5 | / |
| Duck | 2.25 | (i.e. Avian) |
| Caramel | .5-4 | / |
| Salt | 0.2-1.0 | / |
| Potassium sorbate | .005-.01 | / |
| Total Ingredients: | 100 | — |

Methods for making the pet treat according to the present disclosure are described herein. An embodiment method for making a pet treat comprises providing a grain-based composition and a meat-based composition; configuring the grain-based composition, whereby forming an inner portion; and wrapping the inner portion around the inner portion thereby forming the pet treat, wherein the outer portion circumferentially covers at least a substantial portion of the inner portion.

The method for making the pet treat 10 comprises configuring the prepared grain-based composition thereby forming inner portion 115. The inner portion 115 may be formed by standard extrusion process and/or molding process known in the art. A person skilled in the art would understand and control the operational parameters of the extrusion and/or molding process to make the inner portion 115 with a desired size, shape, and configuration. As an example, the inner portion may be formed into a roll-like shape. The method may comprise forming a hollowed space 130 during formation of the inner portion 115. It is noted that the hollowed space 130 may be produced using specially designed extrusion dies or molding parts. In the case of the extruded inner portion, the formation of a hollowed space is achieved by extruding through a round die with a pin in the center to form the hollowed space in the finished inner portion. The size, length, shape, and configuration of the hollowed space 130 may be controlled by selection of facilities/parts and optimization of operational parameters, which are appreciable by a skilled artisan.

The method may comprise forming a plurality of cavities 120 in the pet treat 10. The cavities 120 may be produced automatically by the ingredients of the grain-based composition. As an exemplary example, the grain-based composition may include rice four or tapioca flour/starch, which could spontaneously or automatically generate a plurality of bubbles or void spaces under heat or shear during the extrusion and/or molding process. The generated bubbles once settled form the cavities 120 in the inner portion 115. In embodiments, a substantial portion of the cavities are fully encapsulated by the grain-based composition. Alternatively, the cavities 120 may be produced by aeration. An example of aeration is injecting a gas such as air, N₂, or an inert gas into the grain-based composition, during extrusion/molding process to induce the generation of bubbles within the inner portion 115. Another example of aeration is adding a gas-generating compound such as NaHCO₃ into the grain-based composition, which generates CO₂ upon heating thereby forming air bubbles within the inner portion 115.

The method for making pet treat 10 comprises configuring the meat-based composition thereby forming the outer portion 110. The outer portion 110 may be formed by standard extrusion process and/or molding process using standard industry equipment and facility known in the art. One skilled in the art will be able to select necessary parts and optimize the operational parameters to arrive at the outer portions with desired shape, size, thickness.

The method may comprise wrapping the outer portion 110 circumferentially around the pre-formed inner portion 115 thereby forming the pet treat 10. As discussed above, the meat-based composition upon extrusion or molding may be configured and cut into to a sheet. The prepared inner portion can be placed onto the meat-based sheet. The inner portion is subsequently wrapped with the sheet either manually or automatically by a machine such as a robot arm. A binding agent or an edible adhesive as described herein may be added or applied to increase the adhesion between the inner portion and the outer portion. As a result, the outer portion 110 circumferentially surrounds and covers at least a substantial portion of the inner portion 115. The method may further comprise configuring the outer portion 110 to cover the inner portion 115 and/or the hollowed space 130 fully, substantially, or partially at one side or both sides of the pet treat 10, as discussed previously. In such cases, the outer portion 110 may be longer than the inner portion 120 along the central axis prior to wrapping.

Alternatively, the outer portion 110 may be formed into a tube-like shape configured to receive and accommodate the pre-formed inner portion 115, by extruding or molding the meat-based composition. The inner portion 115 is then disposed within the outer portion such that the outer portion circumferentially covers at least a substantial portion of the inner portion.

Another embodiment of the method for making a pet treat comprises providing a grain-based composition and a meat-based composition; coextruding the grain-based composition and the meat-based composition, whereby forming the pet treat, wherein the grain-based composition forms the inner portion, and the meat-based composition forms the outer portion consisting, and wherein the outer portion circumferentially covers at least a substantial portion of the inner portion.

The coextrusion process allows for efficient production of the pet treat 10 in one step, thereby dispensing the need of wrapping the outer portion onto the pre-formed inner portion. A pet treat having a hollowed space 130 and/or a plurality of cavities 120 may also be made by the co-extrusion process. The co-extrusion process may be carried out by standard industry equipment and facility known in the art. A person skilled in the art would understand and control the operational parameters of the co-extrusion process to make the pet treat with desired size, shape, and configuration.

The methods described herein may optionally comprise a heating or drying step to further stabilize the structure of the formed pet treat or enhance the adhesion between the inner portion and the outer portion.

While various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. In fact, after reading the above description, it will be apparent to one skilled in the relevant art(s) how to implement the disclosure in alternative embodiments. Thus, the present disclosure should not be limited by any of the above-described exemplary embodiments. Accordingly, all suitable modifications and equivalents should be considered as falling within the spirit and scope of the disclosure. The disclosure resides in the claims hereinafter appended.

1. A pet treat comprising:
an inner portion, the inner portion having a first density and comprising a grain-based composition; and
an outer portion circumferentially wrapped around the inner portion, the outer portion having a second density and comprising a meat-based composition,
wherein the first density is less than the second density.

2. The pet treat of claim 1, further comprising a hollowed space confined by the inner portion and around a central axis of the pet treat.

3. The pet treat of claim 2, wherein the hollowed space is through an entire length of the pet treat.

4. The pet treat of claim 1, wherein the inner portion further comprises a plurality of cavities, wherein a substantial portion of the cavities are fully encapsulated by the grain-based composition.

5. The pet treat of claim 1, wherein the pet treat is substantially straight through a length thereof.

6. The pet treat of claim 1, wherein the pet treat has a substantially cylindrical configuration and a substantially uniform cross-section through a length thereof.

7. The pet treat of claim 1, wherein the inner portion has a substantially circular cross-section.

8. The pet treat of claim 1, wherein the inner portion is not substantially covered by the outer portion at a first side, or a second side, or both, of the pet treat.

9. The pet treat of claim 1, wherein the inner portion is substantially covered by the outer portion at a first side, or a second side, or both, of the pet treat.

10. The pet treat of claim 1, wherein the pet treat has an aspect ratio from about 1 to about 20.

11. The pet treat of claim 1, wherein the pet treat has a length from about 1 cm to about 50 cm.

12. The pet treat of claim 1, wherein weigh of the pet treat is from about 1 g to about 50 g.

13. The pet treat of claim 1, wherein the grain-based composition comprises at least one grain selected from the group consisting of wheat, oat, rice, corn, maize, barley, sorghum, rye, millet, amaranth, buckwheat, quinoa, or combinations thereof.

14. The pet treat of claim 1, wherein the grain-based composition comprises a flour selected from the group consisting of oat flour, soy flour, wheat flour, rice flour, potato flour, corn flour, rye flour, buckwheat flour, chestnut flour, chickpea flour, atta flour, pea flour, bean flour, amaranth flour, arrowroot flour, taro flour, cattail flour, acorn flour, sorghum flour, or tapioca flour, or a combination of two or more thereof.

15. The pet treat of claim 1, wherein the outer portion comprises a meat from at one least one animal selected from a group consisting of pork, beef, chicken, duck, goat, horse, buffalo, venison, elk, moose, liver, fish, veal, lamb, turkey, goose, shellfish, bovine, porcine, and combinations thereof.

16. The pet treat of claim 1, wherein the outer portion comprises an anti-oxidant rich material selected from the group consisting of acai berries, blueberries, blackberries, spinach, brown rice, quinoa, chia seeds, flax seeds, wheat grass, pumpkin, salmon, kiwi, asparagus, and combinations thereof.

17. The pet treat of claim 1, further comprising a starch composition derived from one or more plants selected from the group consisting of potatoes, rice, tapioca, corn, rye, wheat, and oats, fruits, nuts, rhizomes, arrowroot, guar gum, locust bean, arracacha, buckwheat, banana, barley, cassava, konjac, kudzu, oca, sago, sorghum, sweet potato, taro, yams, fava beans, lentils and peas.

18. The pet treat of claim 1, further comprising a food additive selected from the group consisting of preservative, sorbitol, desired colorant, glycerin, yeast extract, flavor, salt, cochineal, potassium sorbate, and combinations thereof.

19. The pet treat of claim 1, further comprising one or more auxiliary ingredients comprises a plant material selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, swiss chard, turnip greens, Jerusalem artichoke, jicama, lettuce, mushrooms, okra, onion, parsley, peas, peppers, plantain, pumpkin, radicchio, radish, rutabaga, spinach, sweet potato, tomato, turnip, water chestnut, yams, and combinations thereof.

20. The pet treat of claim 1, further comprising an ingredient selected from the group consisting of binding agent, a moisturizing compound, a salt, a sugar, an acid, a mold inhibitor, a flavoring compound, an aroma compound, a coloring compound, and any combination of two or more thereof.

21. The pet treat of claim 1, further comprising a health ingredient selected from the group consisting of glucosamine, chondroitin, flax seed, calcium, parsley seed, peppermint, chlorophyll, vitamin E, L-carnitine, and lycopene, and combinations thereof.

22. The pet treat of claim 1, wherein the pet treat comprises:
at least about 15 wt % of protein;
at least about 0.05 wt % of fat;
less than about 3% of fiber;
less than about 20 wt % of moisture; and
less than about 10 wt % of ash.

23. The pet treat of claim 1, wherein the inner portion is about 5 wt % to about 80 wt %, based on the total weight of the pet treat.

24. The pet treat of claim 1, wherein the outer portion is about 20 wt % to about 95 wt %, based on the total weight of the pet treat.

25. A method for making a pet treat comprising an inner portion and an outer portion, the method comprising:
providing a grain-based composition and a meat-based composition;
configuring the grain-based composition, whereby forming the inner portion having a first density; and
wrapping the meat-based composition circumferentially around the inner portion, thereby forming the outer portion having a second density, wherein the outer portion circumferentially covers at least a substantial portion of the inner portion,
wherein the first density is less than the second density.

26. The method of claim 25, further comprises forming an internal hollowed space of the inner portion around a central axis of the pet treat.

27. The method of claim 25, wherein forming the inner portion comprises extruding the grain-based composition.

28. The method of claim 25, further comprising forming a plurality of cavities on or within the inner portion.

29. The method of claim 28, wherein forming a plurality of cavities comprising injecting a gas into the grain-based composition during extrusion.

30. The method of claim 25, wherein wrapping the inner portion with the meat-based composition is performed manually.

31. A method for making a pet treat comprising:
providing a grain-based composition and a meat-based composition;
coextruding the grain-based composition and the meat-based composition, whereby forming the pet treat, wherein the grain-based composition forms the inner portion having a first density, and wherein the meat-based composition forms an outer portion having a second density,
wherein the first density is less than the second density.

32. The method of claim 31, further comprises forming an internal hollowed space confined the inner portion around a central axis of the pet treat.

33. The method of claim 31, further comprising forming a plurality of cavities on or within the inner portion.

34. The method of claim 33, wherein forming a plurality of cavities comprising injecting a gas into the grain-based composition during coextrusion.
